(19) United States
(12) Patent Application Publication
(10) Pub. No.: US 2016/0070223 A1
(43) Pub. Date: Mar. 10, 2016

(54) PRINTING APPARATUS, PRINTING METHOD, STORAGE MEDIUM FOR STORING PROGRAM, AND PRINTING SYSTEM

(71) Applicant: CANON KABUSHIKI KAISHA, Tokyo (JP)

(72) Inventor: Junichi Yamakawa, Kashiwa-shi (JP)

(21) Appl. No.: 14/840,442

(22) Filed: Aug. 31, 2015

(30) Foreign Application Priority Data
Sep. 4, 2014 (JP) 2014-180492

(51) Int. Cl. G03G 15/00

(52) U.S. Cl. CPC G03G 15/5058; G03G 15/6582

(57) ABSTRACT

A printed article obtained by printing test data having a plurality of pages is supplied to a finishing apparatus, and information indicating a difference between the configuration of a plurality of pages of an output sheet output from the finishing apparatus and the configuration of the plurality of pages of the printed sheet is acquired. In the case where image data having a plurality of pages is printed on a plurality of sheets and finishing is performed, the image data is processed based on the information indicating the difference such that the configuration of the plurality of pages of the output sheet output from the finishing apparatus is the same as the configuration of the plurality of pages of the image data.

### BACKGROUND OF THE INVENTION

1. Field of the Invention

The present invention relates to a printing apparatus, a printing method and a program stored on a storage medium that are capable of executing a finishing process, and to a printing system.

2. Description of the Related Art

Conventionally, finishers that perform finishing processes such as stapling or punching on sheets output from a printing apparatus are known. In such finishing apparatuses, the printing apparatus and an interface (thereto) are clearly defined in advance, and a configuration is adopted in which detailed/advanced settings are configured in the printing apparatus rather than in the finisher. In a digital front end (DFE) that transmits PDL data as image data to a printing apparatus, it is possible to recognize the type of finisher that is mounted and to perform detailed finishing settings from a printer driver (Japanese Patent Laid-Open No. 7-89256).

Meanwhile, in recent years, so-called external finishers in which setting of finishing processes is performed with an operation unit of the finisher are known, and it has become possible to make the interface between the finisher and the printing apparatus simpler. External finishers include various finishing apparatuses such as a booklet binding device, a case binding device, a ring binder, a stapler and a puncher. Such an external finisher is recognized merely as a single discharge destination by the DFE. In that case, setting of finishing is configured in the external finisher, and printing is performed after the discharge destination has been set in the DFE to the external finisher.

However, it is difficult to designate in detail, from the printing apparatus, positions such as “right”, “left”, “up”, and “down”, for example, in finishing processes such as stapling and punching. In that case, a user needs to set, in the printing apparatus, designation of print options such as “sheet discharge face”, “page order”, and “rotation”, in accordance with a desired finishing position, or to change the orientation of an image on an application.

### SUMMARY OF THE INVENTION

An aspect of the present invention is to eliminate the above-mentioned problems with the conventional technology. The present invention provides a printing apparatus, a printing method and a program stored in a storage medium that reduce a user workload in the case of performing a desired finishing process using an external finisher, and a printing system.

The present invention in one aspect provides a printing apparatus that is connectable to a finishing apparatus that performs finishing on a sheet, the printing apparatus comprising: a test print unit configured to print test data having a plurality of pages; a supply unit configured to supply a printed sheet printed by the test print unit to the finishing apparatus; an acquiring unit configured to acquire information indicating a difference between a configuration of a plurality of pages of an output sheet output from the finishing apparatus and a configuration of a plurality of pages of the printed sheet; and a processing unit configured to, in a case of printing image data having a plurality of pages on a plurality of sheets and performing finishing, process the image data based on the information indicating the difference acquired by the acquiring unit such that the configuration of the plurality of pages of an output sheet output from the finishing apparatus is same as the configuration of the plurality of pages of the image data.

According to the present invention, it is possible to reduce a user workload in the case of performing a desired finishing process using an external finisher.

Further features of the present invention will become apparent from the following description of exemplary embodiments with reference to the attached drawings.

### BRIEF DESCRIPTION OF THE DRAWINGS

FIG. 1 is a diagram showing the configuration of a system for executing finishing process printing.

FIG. 2 is a diagram showing the configuration of an external finisher.

FIG. 3 is a diagram showing the configuration of another external finisher having a staple function.

FIG. 4 is a block diagram representing the configuration of a printing system including an external finisher.

FIG. 5 is a block diagram showing the configuration of software modules of an image forming apparatus.

FIG. 6 is a flowchart showing print processing of a test job.

FIG. 7 is a diagram showing a test job.

FIG. 8 is a diagram showing a print setting screen of a printer driver.

FIG. 9 is a diagram showing a table defining position modes.

FIG. 10 is a diagram showing a state in which a test job is output by an external finisher.

FIG. 11 is a diagram showing an association in a case where input of “1515” is accepted.

FIG. 12 is a flowchart showing processing of setting print job basic attributes.

FIG. 13 is a flowchart showing a finishing process after the processing of FIG. 12.

FIG. 14 is another diagram showing the print setting screen of the printer driver.

FIG. 15 is a diagram showing the output result of a test job in the case of using a two-dimensional barcode.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same components are denoted by the same numerical references, and the description thereof is omitted.

### First Embodiment

System Configuration

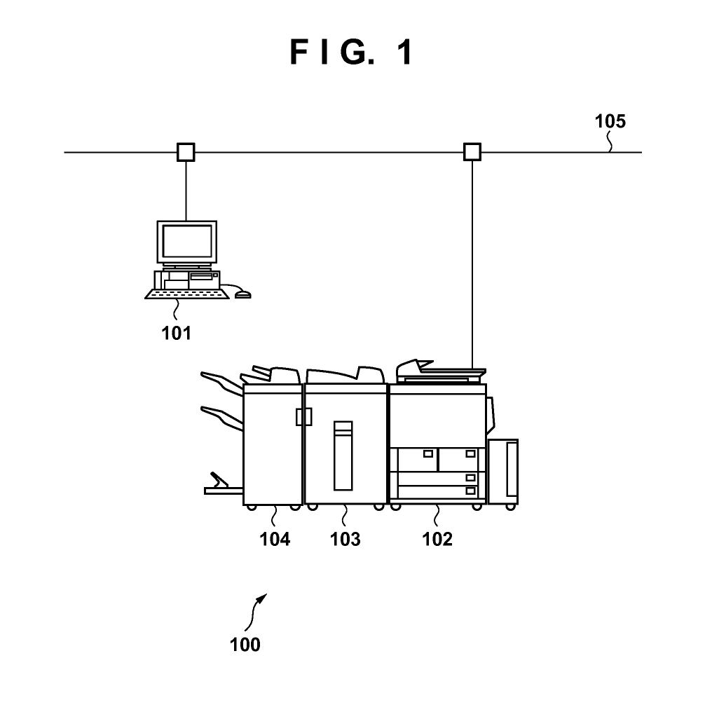

FIG. 1 is a diagram showing the configuration of a system for performing finishing process printing according to this embodiment. The system 100 includes a computer 101 and an image forming apparatus (printing apparatus) 102, which are connected communicably to each other by a network 105 such as a LAN. For example, the computer 101 (print control apparatus), which is a general-purpose PC, transmits, to the image forming apparatus 102, various types of jobs for instructing functions that can be executed by the image forming apparatus 102 based on an instruction from a user accepted on an application. For example, the image forming apparatus 102 is an MFP (multifunctional peripheral) in which a print function, a scan function, a FAX function and the like are integrated, and performs each function based on a job accepted from the computer 101. The image forming apparatus 102 is provided with a print unit (printer engine) for performing the print function. The print unit has a mechanism for performing printing using an inkjet printing method or an electrophotographic method, for example. Moreover, the image forming apparatus 102 has a reading unit (scanner engine) for performing the scan function and an automatic original feeding apparatus for successively feeding an original to the reading unit one sheet at a time.

A stacker and a finishing apparatus (finisher) can be connected downstream of the image forming apparatus 102. In this embodiment, a stacker 103 is connected downstream of the image forming apparatus 102. The stacker 103 enables stacking of a large amount of sheets (printing media) at a time. Moreover, an external finisher 104 is connected downstream of the stacker 103. The external finisher 104 has finishing functions such as a stapling process, a shifting process, or a saddle stitching bookbinding process.

Internal Configuration of External Finisher

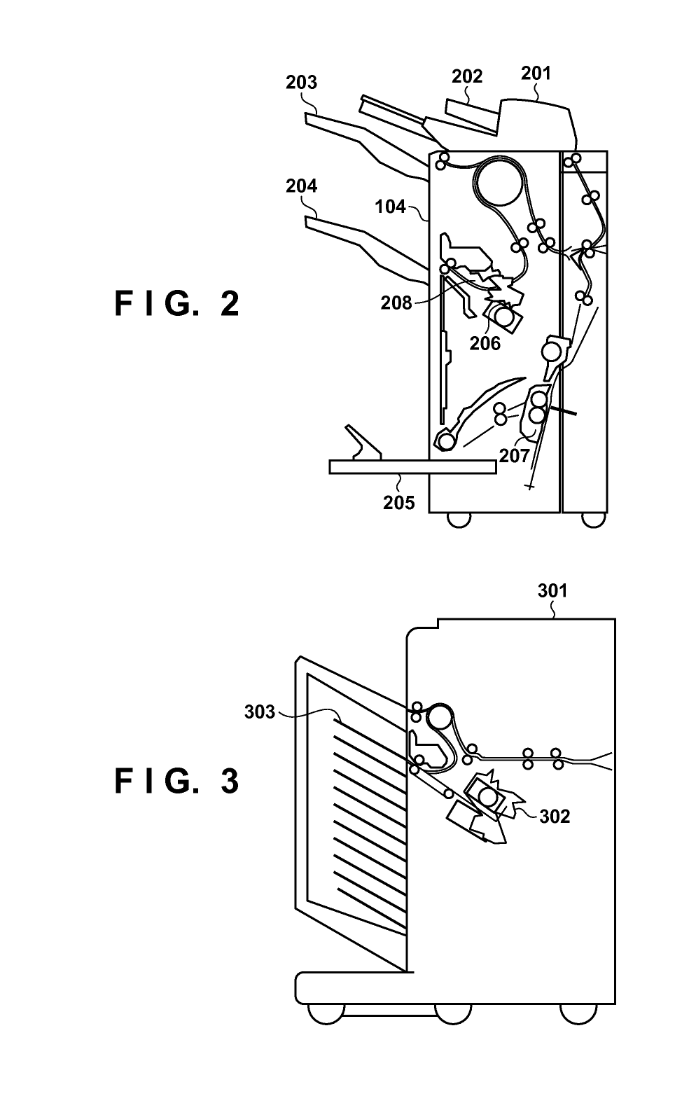

FIG. 2 is a diagram showing the configuration of the external finisher 104. The external finisher 104 has units for performing each of the finishing functions on the sheets conveyed from the image forming apparatus 102.

In the case of performing the stapling process with the finisher 104, the sheets conveyed from the image forming apparatus 102 are conveyed to a stack tray 204. At that time, before the sheets are discharged to the stack tray 204, the sheets are sequentially accumulated on a processing tray 208 one copy at a time. Subsequently, the sheets are stapled from below by a stapler 206 arranged on the processing tray 208, and are discharged to the stack tray 204.

A saddle stitcher 207, after stapling sheets in a middle part thereof at two places, folds the sheets in half by feeding the middle part of the sheets between rollers, and performs the saddle stitching bookbinding process so that a pamphlet-like booklet is generated. The sheets bookbound by the saddle stitcher 207 are discharged to a booklet tray 205.

An inserter 201 sends the sheets set on an insert tray 202 to the stack tray 204 or a sample tray 203. Accordingly, the external finisher 104 can insert the sheets, which have been set on the inserter 201, between sheets printed by the image forming apparatus 102 (intermediate insertion). On the insert tray 202 of the inserter 201, the sheets are set face up by a user, and are fed successively from the uppermost sheet by a pickup roller. Therefore, in the case where the sheets fed by the inserter 201 are conveyed in this state to the stack tray 204 or the sample tray 203, they are discharged face down. Moreover, in the case where the sheets are conveyed to the saddle stitcher 207, the sheets are sent onto a sheet conveying path and switched back, so that the sheets all face in the same direction.

FIG. 3 is a diagram showing the configuration of another external finisher 301 having a staple function similarly to the external finisher 104. The sheets conveyed from the image forming apparatus 102 are sorted and discharged into a plurality of discharge trays 303. Moreover, by the user inserting a stack of sheets into the uppermost sheet discharge tray and pressing a button (not illustrated), it is possible to perform manual stapling with a stapler 302. In the external finisher 301 in FIG. 3, the stapling process is performed on sheets from above.

Configuration of Controller

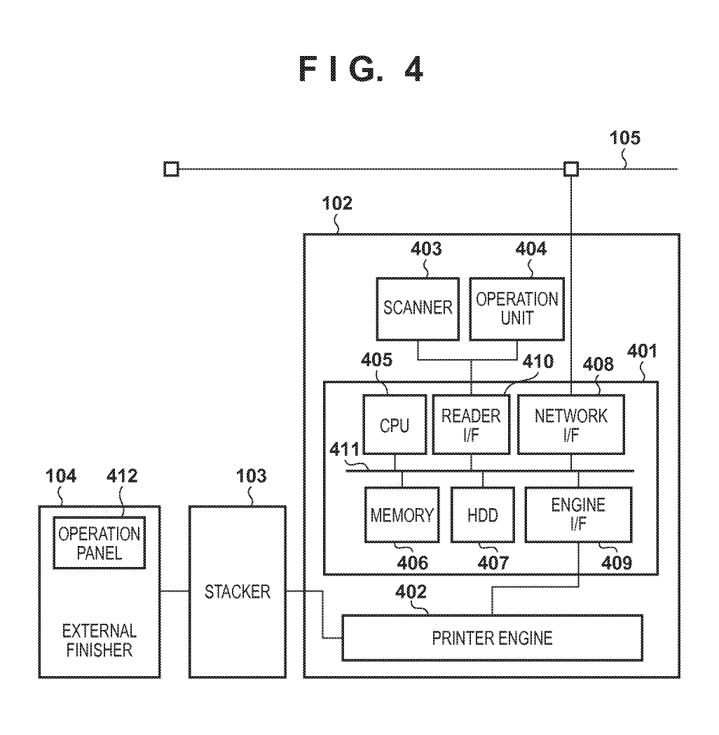

FIG. 4 is a block diagram representing the configuration of a printing system including the image forming apparatus 102, the stacker 103 and the external finisher 104. The image forming apparatus 102 includes a controller 401, a printer engine 402, a scanner 403 and an operation unit 404.

The controller 401 will be described. A central processing unit (CPU) 405 integrally controls, via a system bus 411, the control and the operation of each unit inside the apparatus, and the execution of programs stored in a storage device. The memory 406 is used as a temporary storage area during the operation of the image forming apparatus 102, or as a work memory. A hard disc drive (HDD) 407 is a large capacity storage device and stores various types of programs to be executed by the CPU 405. A network interface (I/F) 408 enables communication with another apparatus such as the host computer 101 via the network 105. An engine interface (I/F) 409 controls communication with the printer engine 402. The printer engine 402 receives test data, or image data to be printed via an engine interface 409, and forms images on sheets. Moreover, the printer engine 402 also performs control of the stacker 103 and the external finisher 104. The external finisher 104 has an operation panel 412 for accepting the setting of a finishing process from a user.

Software Module Configuration

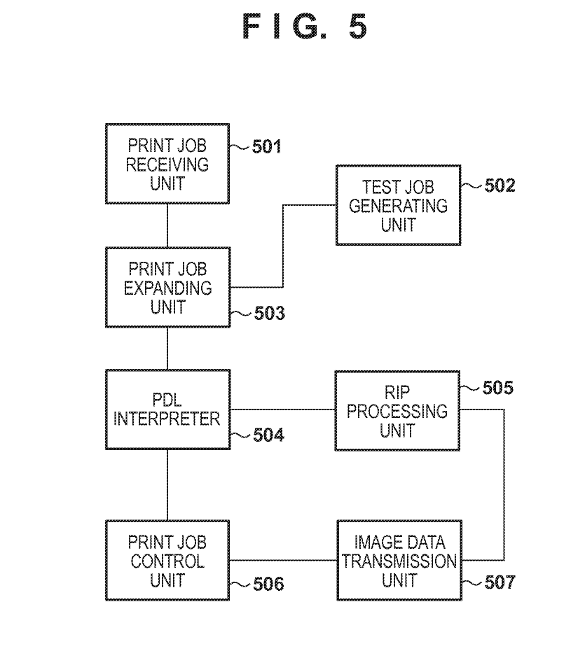

FIG. 5 is a block diagram showing the configuration of software modules of the image forming apparatus 102. Each of the software modules is expanded in the memory 406, read by a program, and executed by the CPU 405.

A print job receiving unit 501 receives a print job transmitted from the computer 101 via the network interface (I/F) 408, and temporarily stores the received print job in the spooler on the memory 406. A print job expanding unit 503 analyzes the received print job, expands it from the spooler, and passes it to a PDL interpreter 504. The PDL interpreter 504 expands PDL (Page Description Language) data contained in the print job, and converts the data into data of an intermediate data format. Here, the PDL data is a PDF (portable document format) by Adobe Systems Inc., for example. A RIP processing unit 505 receives the converted data, performs RIP processing on the data, coverts the data into image data, and temporarily stores the image data in the spooler.

A print job control unit 506 generates a control command to the printer engine 402 regarding the image data stored in the spooler, and sends the control command to the printer engine 402 via the engine interface 409. An image data transmission unit 507 transmits the image data to the printer engine 402 via the engine interface 409 and printing is performed. A test job generating unit 502 generates a test job described later. In this embodiment, the test job is used in order to set appropriate print job basic attributes in the printing system based on the output result of the test job (output article (output sheet)) from the external finisher 104. The print job basic attributes are processes performed on image data when performing a finishing process, and include setting of appropriate page order/print face (sheet discharge face) and rotation of images, for example.

Setting of Print Job Basic Attributes Using Test Job

In this embodiment, the external finisher 104 is treated as a discharge destination by the image forming apparatus 102. As for the finishing process of the external finisher 104, if a finishing setting configured on the operation panel 412 of the external finisher 104 is stapling, for example, single stapling or double stapling is performed. Due to such an interface, the image forming apparatus 102 is not required to recognize a detailed difference between each model of the external finisher 104. However, in an attempt to perform stapling at a desired stapling position, print job basic attributes such as page order, sheet discharge face and page rotation needs to be appropriately set. This setting varies depending on a sheet processing mechanism of each external finisher 104.

A procedure to perform output to the external finisher 104 using a test job and to set, based on an output result thereof, print job basic attributes for each external finisher 104 in the printing system will be outlined hereinafter.

1. On the operation panel 412 of the external finisher 104, a finishing process setting from a user is accepted.

2. In accordance with the external finisher finishing process setting of a printer driver, the image forming apparatus 102 performs printing of the test job.

3. The image forming apparatus 102 accepts code information from the user based on the output result from the external finisher 104.

4. The image forming apparatus 102 associates the accepted code information with the setting content of the external finisher finishing process setting of the printer driver.

5. When the user designates the setting content of the external finisher finishing process setting and instructs printing, printing is performed with an appropriate page order, sheet discharge face, and image rotation.

Printing of Test Job

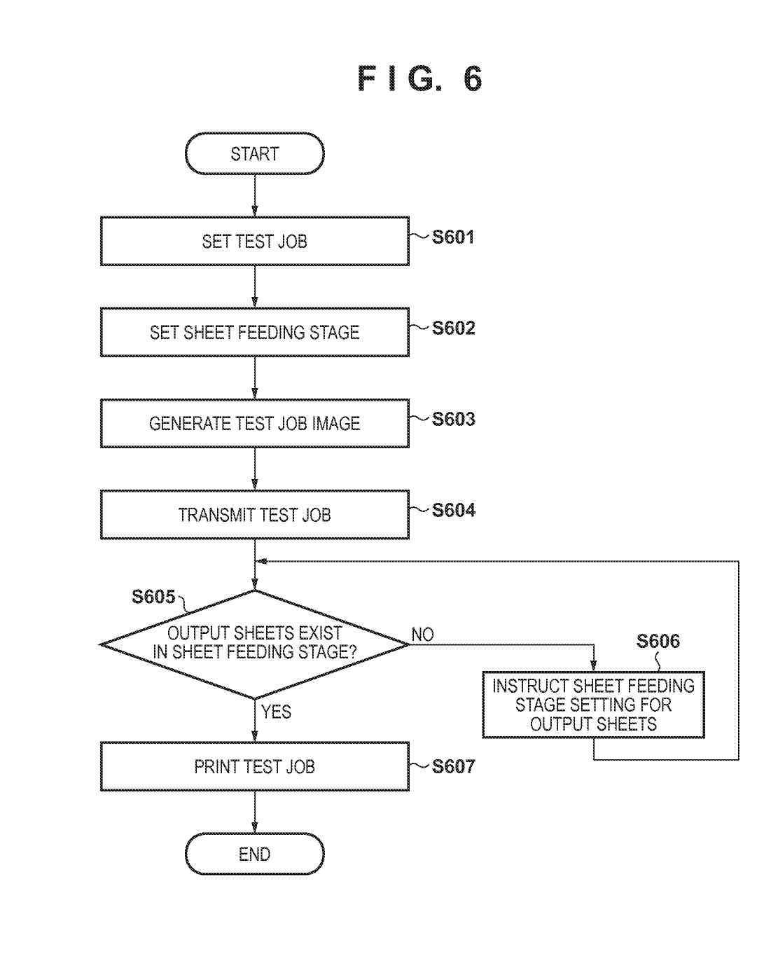

FIG. 6 is a flowchart showing the print processing of a test job. Each process in FIG. 6 is a process performed by the controller 401 and the printer engine 402, and is realized by the CPU 405 executing a program expanded in the memory 406, for example.

Prior to the processing in FIG. 6, on the operation panel 412 of the external finisher 104, the designation of a finishing process is accepted from a user. Here, as an example, it is assumed that the designation of double stapling is accepted.

In step S601, in the operation unit 404 of the image forming apparatus 102, the test job generating unit 502 accepts an instruction to execute the test job from the user. When the test job generating unit 502 accepts the instruction to execute the test job, it acquires a test job setting corresponding to the designated finishing process. The test job setting includes the number of print output pages and a sheet size, for example. The number of print output pages is a number greater than or equal to the minimum number of sheets that can undergo the finishing process in the external finisher 104. Here, it is assumed that the number of the print output pages is eight and the sheet size is A4. The test job setting may be associated with the designated finishing process in advance.

In step S602, the test job generating unit 502 reads a sheet feeding stage (unit, cassette) setting designated in the operation unit 404 of the image forming apparatus 102. In step S603, the test job generating unit 502 generates PDL data based on the settings in steps S601 and S602. Subsequently, the print job expanding unit 503 expands the PDL data, and generates the image data of the test job (test data) on the memory 406 via the PDL interpreter 504 and the RIP processing unit 505.

In step S604, the print job control unit 506 sets double-side designation for the test job, sets the external finisher 104 as the discharge destination, and transmits the test job to the printer engine 402. In step S605, the printer engine 402 determines whether or not there are sheets of a set sheet size in the designated sheet feeding stage. In the case where it is determined here that there are, the operation moves on to step S607. On the other hand, in the case where it is determined that there are no sheets, the print job control unit 506 displays, on the operation unit 404, a message for causing the user to set sheets in step S606. Subsequently, the process of step S605 is repeated.

In step S607, the printer engine 402 prints the test data on sheets, and discharge the sheets to the external finisher 104 (test print). The external finisher 104 performs double-stapling on the printed article (printed sheet) in accordance with the settings configured on the operation panel 412.

Content of Test Job

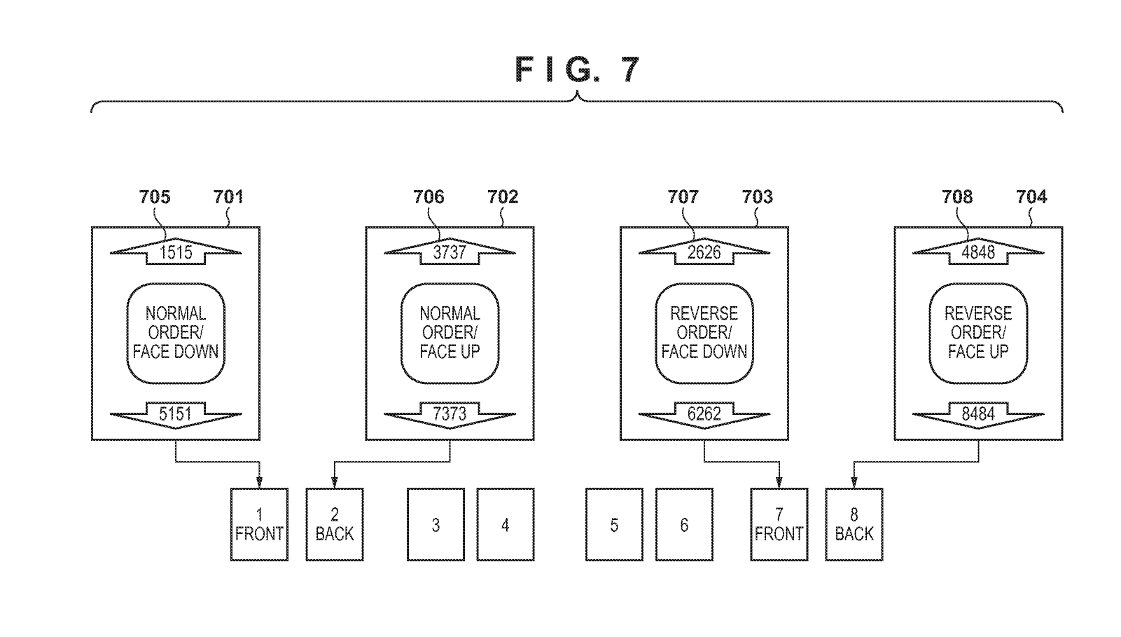

FIG. 7 is a diagram showing one example of the test data used in this embodiment. As shown in FIG. 7, the test data has a plurality of pages. In FIG. 7, A4 LEF (long edge feed) and eight as the number of pages are set for the test job. Moreover, settings have been configured such that an image 701 is printed on the front face of a first page and an image 702 is printed on the back face of the first page. Moreover, settings have been configured such that an image 703 is printed on the front face of a seventh page and an image 704 is printed on the back face of an eighth page. Also, settings have been also configured such that respective corresponding images are printed on a third page to a sixth page.

Arrows indicating the orientation of the pages and identification information (position codes) 705 to 708 for identifying the print job basic attributes are assigned to the images 701 to 704. When printing of the test job shown in FIG. 7 is completed, four sheets corresponding to eight pages are double-stapled and output from the external finisher 104. During the output, the four sheets corresponding to eight pages are double-stapled and output in accordance with the output mechanism of the external finisher 104. For example, if the sheet output mechanism of the external finisher 104 is a mechanism that inverts the front and back faces of sheets and outputs the sheets, the image 702 will be printed and output on the front face of a sheet. Moreover, if the sheet output mechanism of the external finisher 104 is a mechanism that outputs sheets in reverse page order, the image 704 in FIG. 7 will be printed and output on the first page of the stapled sheets. That is, the page configuration of the printed article printed by the image forming apparatus 102 and the page configuration of the output article output by the external finisher 104 may differ from each other in some cases. In this embodiment, the test data having a plurality of pages is printed, supplied to the external finisher 104, and output in accordance with the output mechanism of the external finisher 104. For example, in the case where the output article is in reverse page order, the last page of the test data will be positioned on the uppermost face of the output article. The user inputs, in an image forming apparatus 104, the identification information assigned to a predetermined page in the output article (for example, the page on the uppermost face). Here, in the case where the pages are output in reverse order as in the above example, the identification information indicates processing of printing pages in reverse print order when image data is printed with the image forming apparatus 102 thereafter. That is, it can be said that the identification information is information for absorbing the difference between the page configuration of the output article output from the external finisher 104 based on the test data and the page configuration of the printed article of the test data in the image forming apparatus 102.

Printer Driver

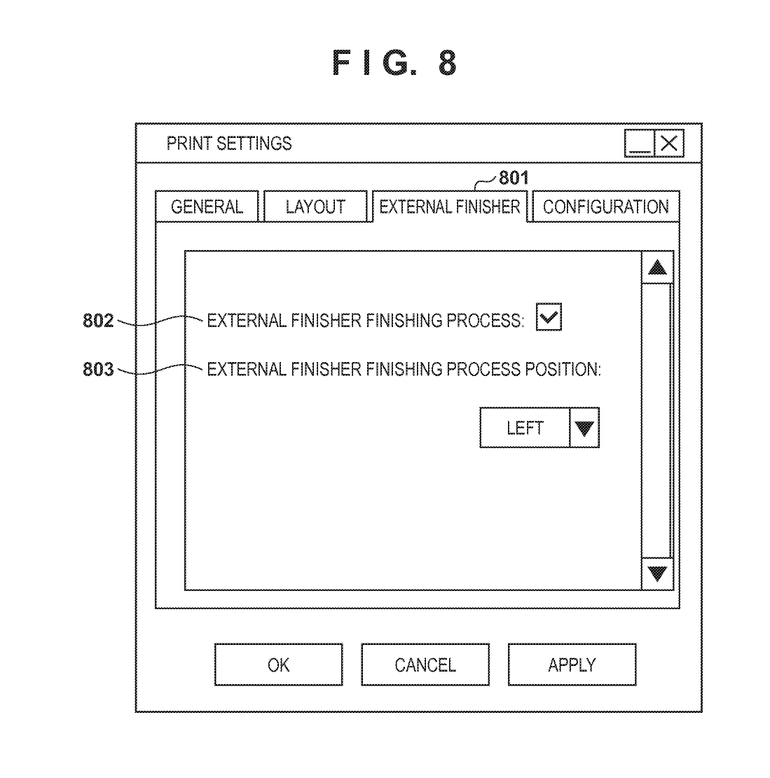

FIG. 8 is a diagram showing one example of a print setting screen of the printer driver in this embodiment. A tab 801 is a tab for displaying the setting items of the finishing processes of the external finisher 104. An item 802 is a checkbox for setting whether or not to perform an external finisher finishing process. An item 803 is a pull-down menu for setting the position of the external finisher finishing process, and “left”, “right”, “up” and “down” can be selected by a user, for example. “Left” indicates that, for example, a stapling position is on the left relative to the normal position of an image (near a left side among four sides), and “right” indicates that, for example, the stapling position is on the right relative to the normal position of the image (near a right side). Moreover, “up” indicates that, for example, the stapling position is on the upper side relative to the normal position of the image (near an upper side), “down” indicates that, for example, the stapling position is on the lower side relative to the normal position of the image (near a lower side).

When a user performs finishing setting of image data to be printed on this user interface screen after printing of the test job is completed, the external finisher finishing process position is set to “left” in the item 803. Then, in this embodiment, the setting “normal page order, face down, image rotation 0 degrees” is performed on the image data, for example. Therefore, the user is not required to rotate the image or change the print order of the pages on an application, thereby improving user operability.

External Finisher Finishing Process Setting from Output Result of Test Job

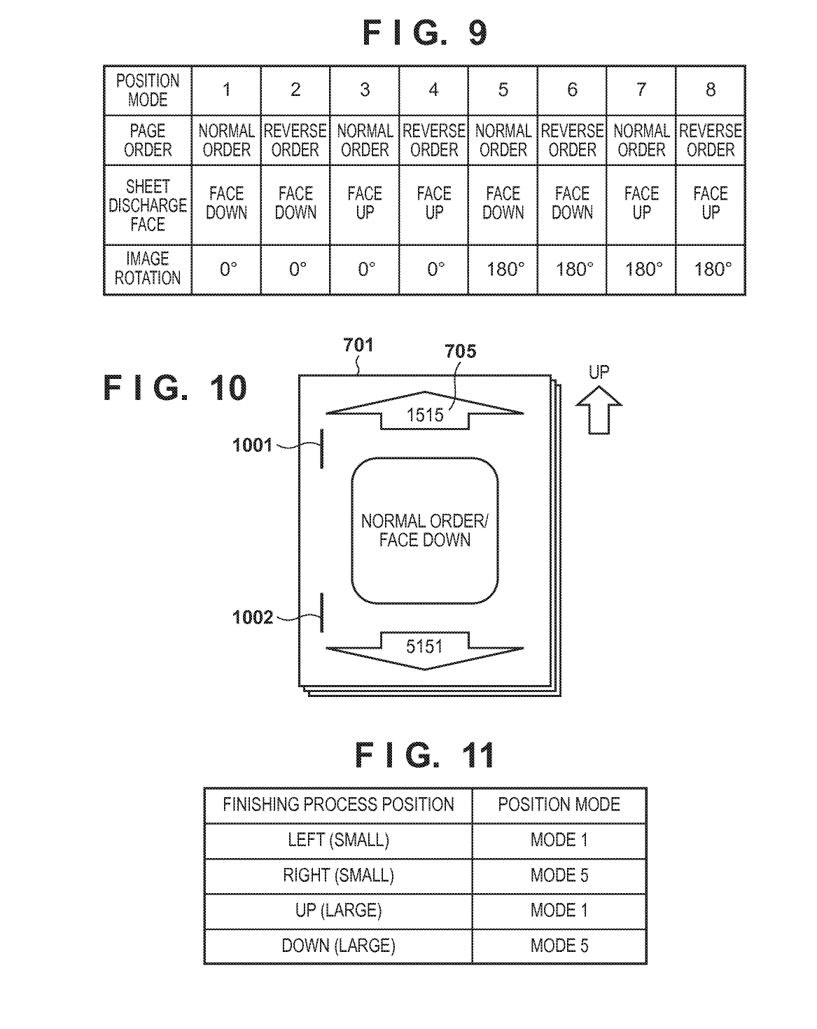

Hereinafter, an operation of setting, for the image data to be printed, appropriate print job basic attributes in accordance with the finishing process of the external finisher 104 (output article) from the output result of the test job will be described. FIG. 9 is a diagram showing a table in which the combination of page order, sheet discharge face, and image rotation as the print job basic attributes is defined as a position mode. The table shown in FIG. 9 is stored in the HDD 407 of the image forming apparatus 102 in advance, for example. Moreover, FIG. 10 is a diagram showing the output result output from the external finisher 104 due to the processing shown in FIG. 6, and, in particular, is a diagram showing one example of the output result for the test data shown in FIG. 7 (A4 size, eight pages). FIG. 10 shows a state where the image 701 in FIG. 7 is output on the uppermost face of sheets stapled with staples 1001 and 1002. However, there are cases where the image 702 in FIG. 7 is output on the uppermost face of stapled sheets due to the output mechanism of the external finisher 104.

After the processing shown in FIG. 6, the user confirms the positions of the double staples 1001 and 1002 in the output result, and refers to the position code on the upper side of the page in the case where sheets are rotated so as to bring the stapling position to the left side (reference position) relative to the image on the uppermost face of the output result. For example, in the case where output result shown in FIG. 10 is output after the processing shown in FIG. 6, the user will refer to the position code 705. The position code 705 in that case is “1515”. The user then inputs the position code on the user interface screen on the operation unit 404 of the image forming apparatus 102.

When the input of the position code performed on the operation unit 404 by the user is accepted, the CPU 405 associates the respective items of the external finisher finishing process positions, that is, “left”, “right”, “up” and “down”, with the respective digits of the position code. For example, in the case where input of “1515”, which is denoted by the position code 705 in FIG. 10, is accepted, “left” is associated with “1”, “right” with “5”, “up” with “1”, and “down” with “5”. FIG. 11 is a diagram showing one example of the association in the case where input of “1515” is accepted.

In this embodiment, by performing such an association, a position mode 1 in FIG. 9 is applied when, after the processing in FIG. 6, the user performs finishing setting of the image data to be printed on the screen in FIG. 8 and sets the external finisher finishing process position to “left” in the item 803. In this case, the setting is configured such that a page order is normal, printing is performed face down, and image rotation is 0 degrees (the image is not rotated). Therefore, the user does not need to set page print order, sheet discharge face, image rotation or the like.

Moreover, in the case where the position is set to “right”, a position mode 5 in FIG. 9 is applied. That is, the page order is normal, printing is performed face down, and image rotation is 180 degrees. The user selecting “right” indicates stapling on the right side relative to the image in a normal position. However, the stapling position of the external finisher 104 cannot be changed due to the structure thereof, and therefore the image will be rotated by 180 degrees so as to cope with this structural inflexibility.

The relation between the case where the position is set to “up” and the case where it is set to “down” is the same as the relation between the above-described case where the position is set to “left” and the above-described case where it is set to “right”.

Description will be given regarding the case where the image 702 is printed and output on the uppermost face, unlike FIG. 10, after the processing in FIG. 6. In that case, the user inputs “3737” denoted by the position code 706 on the operation unit 404. Then, the CPU 405 associates the external finisher finishing process positions “left”, “right”, “up”, and “down” with the respective digits of the position code “3737”. That is, “left” is associated with “3”, “right” with “7”, “up” with “3”, and “down” with “7”.

After the processing in FIG. 6, when the user performs finishing setting of image data to be printed on the screen in FIG. 8 and sets the external finisher finishing process position to “left” in the item 803, a position mode 3 in FIG. 9 is applied. In that case, the setting are configured such that the page order is normal, printing is performed face up, and image rotation is 0 degrees (the image is not rotated). That is, because the front face and the back face of the sheets will be inverted due to the output mechanism of the external finisher 104 unlike the case of FIG. 10 when the sheets are output by the external finisher 104, setting is configured in advance so as to invert the setting of the faces of the sheets to be printed by the image forming apparatus 102.

Moreover, in the case where the position is set to “right”, a position mode 7 in FIG. 9 is applied. That is, the settings are configured such that the page order is normal, printing is performed face up, and image rotation is 180 degrees. The user selecting “right” indicates stapling on the right side relative to the image in a normal position. However, the stapling position of the external finisher 104 cannot be changed due to a structure thereof, and therefore the image will be rotated by 180 degrees so as to cope with this structural inflexibility.

The relation between the case where the position is set to “up” and the case where it is set to “down” is also the same as the relation between the above-described case where it is set to “left” and the case where it is set to “right”.

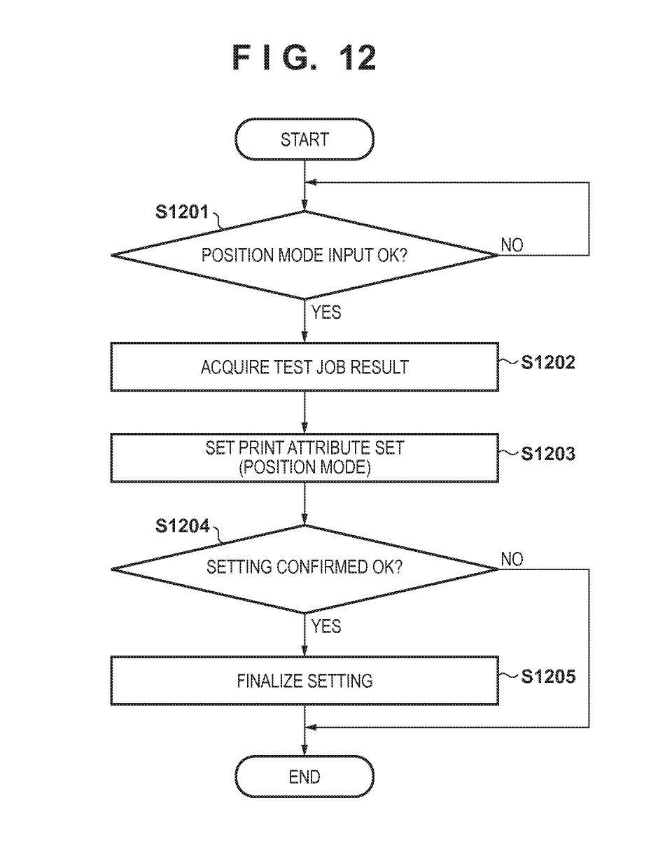

FIG. 12 is a flowchart showing the processing of setting the print job basic attributes based on the output result of the external finisher 104. Each process in FIG. 12 is realized by the CPU 405 reading and executing a program expanded in the memory 406, for example.

In step S1201, the print job control unit 506 determines whether or not input of a position code from the operation unit 404 has been accepted. In the case where it is determined here that input has not been accepted, the process of step S1201 is repeated until it is determined that input has been accepted. In the case where it is determined that input has been accepted, the operation moves on to step S1202. It is assumed here that “1515” denoted by the position code 705 has been input on the operation unit 404.

In step S1202, the print job control unit 506 acquires the position code 705 “1515”. In step S1203 each setting of the finishing process positions and each of the digits of the position code are associated, with reference to the table in FIG. 9. As described above, here, in the case where the position is set to “left (small)”, it is associated with the mode 1 (normal order, face down, and 0 degrees rotation).

In step S1204, the print job control unit 506 performs display for confirming whether or not the position mode associated in the operation unit 404 in step S1203 is to be finalized. For example, a popup screen containing the content shown in FIG. 11 and OK/cancel buttons may be displayed. In step S1204, the print job control unit 506 further determines whether or not the OK button has been pressed by the user. In the case where it is determined here that the OK button has been pressed, in step S1205, the print job control unit 506 then performs determination/update of the setting of the external finisher finishing process position, closes the display on the operation unit 404, and ends the processing in FIG. 12. On the other hand, in the case where it is determined that it has not been pressed, the processing in FIG. 12 is ended in this state.

Printing Using External Finisher Finishing Process

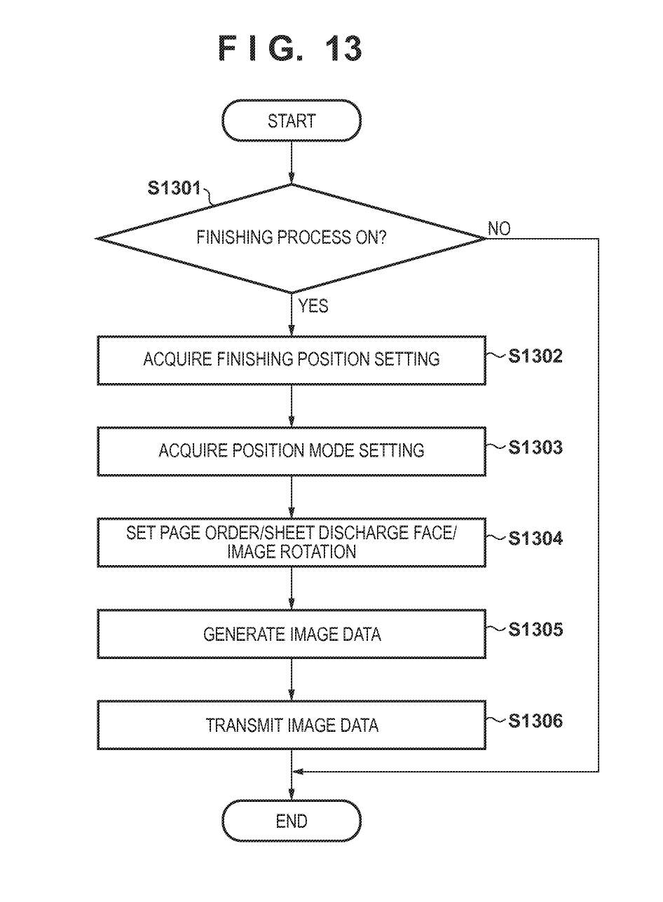

FIG. 13 is a flowchart showing the processing of performing output from the image forming apparatus 102 to the external finisher 104 after the processing in FIG. 12. Each process in FIG. 13 is realized by the CPU 405 reading and executing a program expanded in the memory 406.

Prior to the processing in FIG. 13, the print job receiving unit 501 of the image forming apparatus 102 receives a print job from the computer 101, and acquires the setting contents of the items 802 and 803. The setting contents include on/off of the external finisher finishing process and the external finisher finishing process position.

In step S1301, a print expanding unit 503 expands the received print job, and the PDL interpreter 504 determines whether or not the setting of the external finisher finishing process is on (or off). In the case where it is determined here that the setting is not on (off), the processing in FIG. 13 is ended. On the other hand, in the case where it is determined that the setting is on, the operation moves on to step S1302.

In step S1302, the print job control unit 506 acquires, from the PDL interpreter 504, the setting of the external finisher finishing process position indicated by the item 803. Then, in step S1303, the print job control unit 506 acquires a position mode corresponding to the set external finisher process position. That is, in the case of above-described example (position code “1515”), the position mode 1 corresponding to “left” is acquired, for example.

In step S1304, the print job control unit 506 sets the attributes of page order, sheet discharge face, and image rotation, which are print job basic attributes, as print attributes of the image data to be printed, in accordance with the content of the position mode. In step S1305, the RIP processing unit 505 generates image data from the PDL data, and stores the image data in the memory 406. In step S1306, the print job control unit 506 sends the image data, along with the print attributes set in step S1304 to the printer engine 402, and ends the processing in FIG. 13.

After the processing in FIG. 13, the printer engine 402 prints the image data of the print job on sheets, and supplies the image data to the external finisher 104. The external finisher 104 performs the finishing process in accordance with the settings configured on the operation panel 412 and outputs the sheets.

As described above, in this embodiment, the user confirms the position code in a predetermined position (the upper part of the uppermost face) based on the output result of the test job, and inputs the position code to the operation unit 404 of the image forming apparatus 102. The image forming apparatus 102 associates the position modes in FIG. 9 with the respective settings of the external finisher finishing process positions (“left” to “down”) based on the accepted position code. As a result, in the case where the user thereafter performs finishing output on image data to be printed, the user does not need to perform setting such as that of image rotation or page order rearrangement, thereby improving user operability.

### Second Embodiment

In the first embodiment, the external finisher finishing process is of one type (stapling), but this may be changed such that a plurality of finishing processes are supported. Usually, the external finisher 104 includes the settings of a plurality of finishing processes such as stapling, punching and saddle stitching bookbinding, and therefore print basic attributes and a finishing position process of each of the finishing processes are associated with each other using a test job and test data every time a finishing process is set. Moreover, the external finisher 104 can be connected to a plurality of lines, and print job basic attributes may be associated with a binding position of a case binding device or a ring binder using a test job.

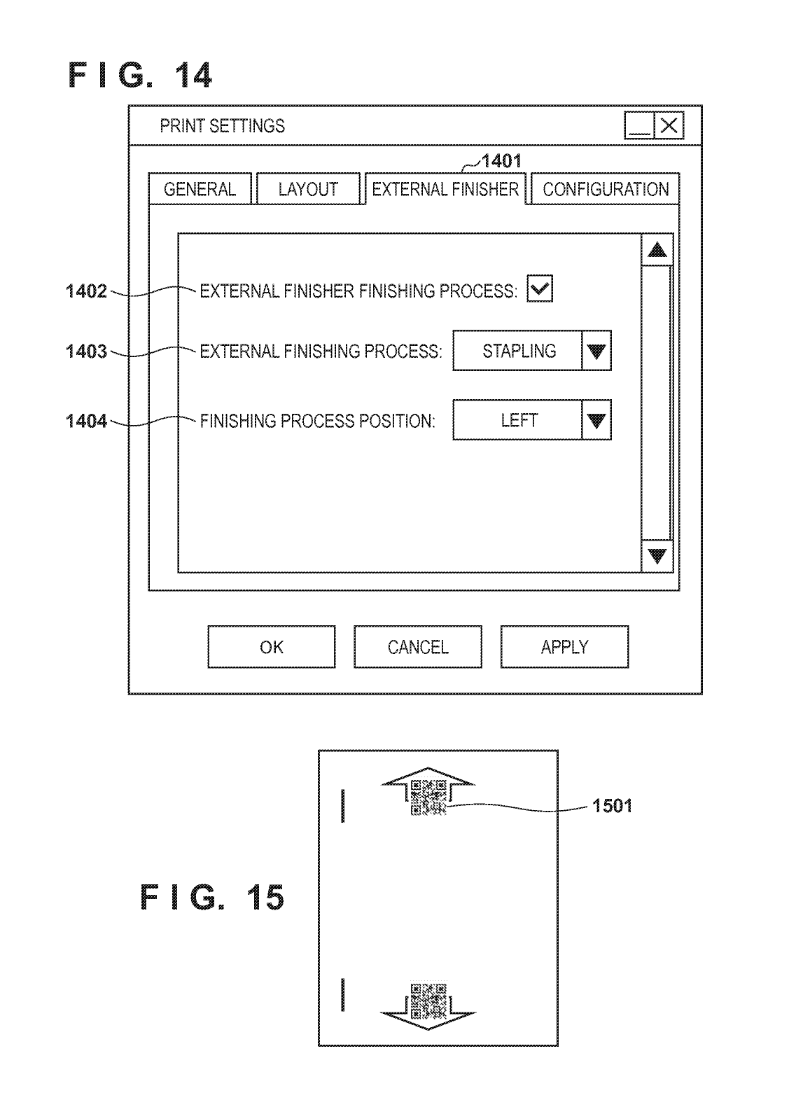

FIG. 14 is a diagram showing the print setting screen of the printer driver corresponding to a plurality of finishing processes of the external finisher 104. A tab 1401 is a tab for setting finishing processes of the external finisher 104. Moreover, an item 1402 is a checkbox to set whether or not to perform an external finisher finishing process. Moreover, an item 1403 makes it possible for the user to select, using a pull-down menu for selecting a finishing process, any from a plurality of finishing processes such as stapling, double stapling, punching, case binding or ring binding. An item 1404 is a pull-down menu for setting an external finisher finishing process position, and “left”, “right”, “up”, or “down” can be selected by the user. The controller 401 performs printing of test data every time a finishing process is set using the item 1403. Then, similarly to the first embodiment, input of a position code is accepted, and a finishing position and print job basic attributes are associated.

### Third Embodiment

In the first embodiment, when performing setting of an external finisher finishing process based on a test job, the user inputs, on the operation unit 404, a position code on the output result of a test job. In this embodiment, the scanner 403 optically reads a two-dimensional barcode, and print job basic attributes and external finisher finishing process settings are associated with each other.

FIG. 15 is a diagram showing the output result of test data in the case where a two-dimensional barcode is used as a position code 1501. Moreover, in the first embodiment, setting of an external finisher finishing process was performed using the printer driver, but the external finisher finishing process may be set using a hot folder or a virtual printer which is generated from the output result of test data.

### Fourth Embodiment

In the first embodiment, the controller 401 of the image forming apparatus 102 performed the association of print job basic attributes based on the print result of test data, but this may be performed in a printer driver. For example, a user inputs a position code in “device settings” in the properties of the printer driver. The printer driver then associates the setting of an external finisher process position with a print job basic attribute.

When generating PDL data, the printer driver issues, to the image forming apparatus 102, a PDL command to designate the setting of the associated print job basic attributes, for example, “page order is normal, sheet discharge face is face down, and image rotation is 0 degrees”. The image forming apparatus 102 executes the print job of the generated PDL data, which is supplied to the external finisher 104, where a finishing process is performed. The result thereof is the same as that of the first embodiment.

Although description was given above indicating various examples and embodiments of the present invention, a person skilled in the art will appreciate that the gist and scope of the present invention are not limited to the specific description given herein.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-180492, filed Sep. 4, 2014, which is hereby incorporated by reference herein in its entirety.

What is claimed is:

1. A printing apparatus that is connectable to a finishing apparatus that performs finishing on a sheet, the printing apparatus comprising:
a test print unit configured to print test data having a plurality of pages;
a supply unit configured to supply a printed sheet printed by the test print unit to the finishing apparatus;
an acquiring unit configured to acquire information indicating a difference between a configuration of a plurality of pages of an output sheet output from the finishing apparatus and a configuration of a plurality of pages of the printed sheet; and
a processing unit configured to, in a case of printing image data having a plurality of pages on a plurality of sheets and performing finishing, process the image data based on the information indicating the difference acquired by the acquiring unit such that the configuration of the plurality of pages of an output sheet output from the finishing apparatus is same as the configuration of the plurality of pages of the image data.

2. The printing apparatus according to claim 1,
wherein the acquiring unit acquires at least one of page order reversal, print face inversion, and image rotation as the information indicating the difference.

3. The printing apparatus according to claim 1,
wherein the processing unit performs, on the image data, at least one process out of change print page order, invert print face of sheets, and rotate image.

4. The printing apparatus according to claim 1,
wherein identification information indicating a process for causing the configuration of the plurality of pages of the output sheet to be same as the configuration of the plurality of pages of the image data is assigned to each page of the test data, and
the acquiring unit acquires the identification information assigned to a page of the test data corresponding to a predetermined page of the output sheet as the information indicating the difference.

5. The printing apparatus according to claim 4, further comprising:
an association unit configured to associate a process indicated by the identification information acquired by the acquiring unit with a position on a sheet on which finishing is executable,
wherein the processing unit performs, on the image data, a process associated by the association unit with a position on a sheet of which finishing is to be performed.

6. The printing apparatus according to claim 5,
wherein the identification information is four numbers respectively identifying four processes, and
the association unit associates the four numbers with four positions on a sheet on which finishing is executable.

7. The printing apparatus according to claim 6,
wherein the processing unit performs, on the image data, a process identified by a number associated by the association unit with a position on a sheet on which finishing is to be performed.

8. The printing apparatus according to claim 4,
wherein the acquiring unit acquires the identification information via a user interface screen.

9. The printing apparatus according to claim 4,
wherein the identification information is a two-dimensional barcode.

10. The printing apparatus according to claim 1,
wherein the finishing includes a stapling process performed near any of four sides of the sheets.

11. A printing method performed in a printing apparatus that is connectable to a finishing apparatus that performs finishing on a sheet, the printing method comprising:
a test print step of printing test data having a plurality of pages;
a supply step of supplying a printed sheet printed in the test print step to the finishing apparatus;
an acquiring step acquiring information indicating a difference between a configuration of a plurality of pages of an output sheet output from the finishing apparatus and a configuration of a plurality of pages of the printed sheet; and
a processing step of, in a case of printing image data having a plurality of pages on a plurality of sheets and performing finishing, processing the image data based on the information indicating the difference acquired in the acquiring step such that the configuration of the plurality of pages of an output sheet output from the finishing apparatus is same as the configuration of the plurality of pages of the image data.

12. A non-transitory computer-readable storage medium storing a program for causing a computer to execute:
a test print step of printing test data having a plurality of pages;
a supply step of supplying a printed sheet printed in the test print step to a finishing apparatus;
an acquiring step acquiring information indicating a difference between a configuration of a plurality of pages of an output sheet output from the finishing apparatus and a configuration of a plurality of pages of the printed sheet; and
a processing step of, in a case of printing image data having a plurality of pages on a plurality of sheets and performing finishing, processing the image data based on the information indicating the difference acquired in the acquiring step such that the configuration of the plurality of pages of an output sheet output from the finishing apparatus is same as the configuration of the plurality of pages of the image data.

13. A printing system that includes a print control apparatus for controlling a printing apparatus and the printing apparatus that is connectable to a finishing apparatus that performs finishing on a sheet,
the printing apparatus comprising:
a test print unit configured to print test data having a plurality of pages; and
a supply unit configured to supply a printed sheet printed by the test print unit to the finishing apparatus,
the print control apparatus comprising:
an acquiring unit configured to acquire information indicating a difference between a configuration of a plurality of pages of an output sheet output from the finishing apparatus and a configuration of a plurality of pages of the printed sheet; and
a processing unit configured to, in a case of printing image data having a plurality of pages on a plurality of sheets and performing finishing, process the image data based on the information indicating the difference acquired by the acquiring unit such that the configuration of the plurality of pages of an output sheet output from the finishing apparatus is same as the configuration of the plurality of pages of the image data.
